(19) United States
(12) Patent Application Publication
(10) Pub. No.: US 2009/0249229 A1
(43) Pub. Date: Oct. 1, 2009

(54) SYSTEM AND METHOD FOR DISPLAY OF RELEVANT WEB PAGE IMAGES

(76) Inventor: Or Offer, Zur Hadassa (IL)

Correspondence Address: DR. D. GRAESER LTD., 9003 FLORIN WAY, UPPER MARLBORO, MD, 20772, US

(21) Appl. No.: 12/409,773

(22) Filed: Mar. 24, 2009

Related U.S. Application Data
(60) Provisional application No. 61/064,798, filed on Mar. 27, 2008.

(51) Int. Cl. G06F 3/01; G06Q 30/00

(52) U.S. Cl. 715/760; 705/14

(57) ABSTRACT

A system and method for viewing visual information about one or more web sites that are related or similar to the web site that is currently being displayed, for example with a web browser or other software interface. The system and method assist the user to access related web sites and also may optionally expand the knowledge of the user in regard to a subject of interest that is being displayed through the web site. The related web sites are shown as links within a user interface, which may optionally be placed at either side, above or below the web page being displayed, or indeed at any other location. Each link is accompanied by a thumbnail image of the page to which it links. The link may optionally be embedded within the thumbnail or alternatively may be displayed separately from the thumbnail image. The links and the thumbnail images are preferably displayed on a special toolbar. The toolbar may optionally appear on each side of the page (horizontally on the left side, horizontally on the right side, vertically at the bottom of the page or vertically at the top of the page) or indeed at any other location.

This Application claims priority from U.S. Provisional Application No. 61/064,798, filed on Mar. 27, 2008 which is hereby incorporated by reference as if fully set forth herein.

### FIELD OF THE INVENTION

The present invention relates to web page presentation and web advertising.

### BACKGROUND OF THE INVENTION

User access to electronic information has grown exponentially over the years. Mass storage devices, such as CD-ROMs, DVDs, hard disks, etc., store more information than ever before. Through them users can access encyclopedias, dictionaries, directories, indices, electronic bibliographies, and other large collections of information on their local computer. Moreover, access to networks, particularly the Internet, provides other opportunities to receive and browse information. For example, through personal computers connected to the Internet, users send and receive email, post on message boards, chat through instant messaging software, maintain calendars electronically, browse classified ads at news sites, look up address book information, browse websites of interest, search for information, and perform many other similar tasks. Other electronic devices such as cell phones, game consoles, personal digital assistants (PDAs) provide similar functionality.

As access and reliance upon electronic devices as means for gathering and viewing information has grown, so has the need for better tools to search, view, and browse the information. Also, an improved user interface for performing such actions may improve the user experience.

In particular when viewing a particular web site it is not easy to obtain summarized information about a related or similar web site and to access those web sites.

US Publication No. 2006/263683 describes a technique that helps users navigate collections of information and the underlying reference items in the collections with a reduced need to perform search queries. For example, a user browsing an Internet sports site might be shown dynamically generated links to fantasy sports websites, sports and team message boards, and other sports-related sites. Clicking on a dynamically generated link, such as a fantasy sports website link, redirects the user to a new site. When the user arrives at the new site, the dynamically generated links and any other suggested information are automatically updated. However, the taught method does not provide any information about the site to which the link is directed.

### SUMMARY OF THE INNOVATION

The background art does not teach or suggest how to view summarized information about related web sites and also have the ability to access these sites from the same web page.

The present invention overcomes these deficiencies of the background art by providing a system and method for viewing visual information about one or more web sites that are related or similar to the web site that is currently being displayed, for example with a web browser or other software interface. The system and method assist the user to access related web sites and also may optionally expand the knowledge of the user in regard to a subject of interest that is being displayed through the web site. The related web sites are shown as links within a user interface, which may optionally be placed at either side, above or below the web page being displayed, or indeed at any other location. Each link is accompanied by a thumbnail image of the page to which it links. The link may optionally be embedded within the thumbnail or alternatively may be displayed separately from the thumbnail image. The links and the thumbnail images are preferably displayed on a special toolbar. The toolbar may optionally appear on each side of the page (horizontally on the left side, horizontally on the right side, vertically at the bottom of the page or vertically at the top of the page) or indeed at any other location.

The thumbnail image provides the user with a visual summary of the new, linked web site, enabling the user to decide whether to click on the link with a mouse or any other pointing device, in order to have the linked web site displayed (ie to “open” the web site). Placing the mouse or, optionally, any other pointing device, over a thumbnail image optionally and preferably reveals this website.

According to some embodiments, the present invention provides a display of an advertising site (dynamic thumbnail sponsored link). The dynamic thumbnail sponsored link is preferably displayed as a thumbnail image with a link to the site. Each site may optionally have one or more dynamic thumbnail sponsored links called “sponsored thumbnail image dynamic links”. If there is more than one dynamic thumbnail sponsored link, a random algorithm is preferably used to select a link. This algorithm also takes into consideration the amount of money that is paid for the advertisement. The billing method may be done on a pay per click basis. “Pay per click (PPC) is an advertising model used on search engines, advertising networks, and content websites/blogs, where advertisers only pay when a user actually clicks on an advertisement to visit the advertiser's website. Generally, advertisers bid on keywords they predict their target market will use as search terms when they are looking for a product or service. When a user types a keyword query matching the advertiser's keyword list, or views a page with relevant content, the advertiser's ad may be shown. These ads are called a “Sponsored thumbnail image dynamic link” or “sponsored ads”. Pay per click ads may also appear on content network websites. In this case, ad networks such as Google AdSense and Yahoo! Publisher Network attempt to provide ads that are relevant to the content of the page where they appear, and no search function is involved.

According to other embodiments, the present invention features a smart engine, which monitors the currently displayed web site and generates a list of similar or related web sites. The list is preferably generated by a robot that optionally searches for all related links for a specific site, and optionally stores the related links and thumbnail images of the related sites in a database. The robot ranks the links according to popularity and provides a sorted list of links.

According to this embodiment, related sites are preferably found according to information residing in the web page. Such information can be, for example, metadata (information regarding the web page that is included in the web page and is usually defined in the header of the page), text that appears on the web page and the like, or a combination thereof. The system preferably compares this information to the information that resides on the currently displayed web page. The system preferably looks for identity of information (for example for appearance of the same key words on both the current displayed page and the page that it's relevancy is currently tested) or for similarity of information or a combination thereof.

The links are preferably displayed on the toolbar and are preferably sorted in the database according to popularity, such that the first most popular link is optionally displayed at the top of the toolbar.

According to other embodiments, the present innovation features a mechanism for randomly choosing the dynamic thumbnail sponsored link to be displayed (if any). The algorithm of choosing the dynamic thumbnail sponsored link is preferably also based on the price that is paid by the sponsors. Optionally the application also provides a tool bar on which the thumbnail images and the links of the sites are displayed.

By “web page” it is meant any mark up language document or any mark-up language related format, for example including but not limited to Flash™ (Flex™)/Silverlight™ or similar technologies (termed herein “browser graphic technologies”), various mark-up languages including HTML, XML and the like.

According to other embodiments of the present invention, the system optionally selects the dynamic thumbnail sponsored link to be displayed according to criteria including one or more of similarity with the current displayed page, web page owner requirements, information about the user, the audience to which the displayed web page refers to and the like. The similarity with the current displayed page is determined by using information that exists on the web page. Such information can be, for example, key words, meta data and the like. The web page owner can, for example, ban the displaying of advertisements of a competitor, or the displaying of immoral or offensive advertisements. Information about the user, such as the user's age and gender, the user's preferences and the like is preferably provided to the system by a third party. The audience to which the web page refers to can be obtained by the web page meta data. The audience can optionally be categorized according to age, gender, preferences, activities, hobbies and the like.

According to other embodiments the system can optionally present one or more sponsored advertisements that feature video or other media format data, in addition to a thumbnail. The system can optionally display an advertisement widget that appears on the website as requested by the owner and shows related websites and advertisement, rather than appearing in a sidebar (or alternatively in addition to such display). Such an advertisement widget optionally has restrictions regarding the type of other websites and advertisements that may be shown. Such restrictions can be, avoiding the display of competitors' web sites and the like.

Optionally and preferably the system and method of the present invention may provide a display to a user on various media display platforms for example including but not limited to a computer monitor and/or other computer display, television, PDA, iPod™, MP3 player, pager, mobile telephone, smart phone or the like.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager. Any two or more of such devices in communication with each other, and/or any computer in communication with any other computer may optionally comprise a “computer network”.

A “web browser” is a software application that enables a user to display and interact with text, images, videos, music and other information, or any type of mark-up language document or web page as described herein, for example at a website on the World Wide Web or a local area network or any other computer network. Text and images on a Web page can contain hyperlinks to other Web pages at the same or different website. Web browsers allow a user to quickly and easily access information provided on many Web pages at many websites by traversing these links. Web browsers format HTML information for display, so the appearance of a Web page may differ between browsers. Some of the Web browsers available for personal computers include Internet Explorer, Mozilla Firefox, Safari, and Opera in order of descending popularity. Although browsers are typically used to access the World Wide Web, they can also be used to access information provided by Web servers in private networks or content in file systems.

A “web site” (alternatively, web site or Web site) is a collection of Web pages, images, videos or other digital assets that is hosted on one or several Web server(s), usually accessible via the Internet, cell phone or a LAN. A Web page is a mark-up language document, typically written in HTML or XML that is almost always accessible via HTTP, a protocol that transfers information from the Web server to display in the user's Web browser. All publicly accessible websites are seen collectively as constituting the “World Wide Web”. The pages of websites can usually be accessed from a common root URL called the homepage, and usually reside on the same physical server. The URLs of the pages organize them into a hierarchy, although the hyperlinks between them control how the reader perceives the overall structure and how the traffic flows between the different parts of the sites. Some websites require a subscription to access some or all of their content. Examples of subscription sites include many business sites, parts of many news sites, academic journal sites, gaming sites, message boards, Web-based e-mail, services, social networking website, and sites providing real-time stock market data.

A “web server” is a computer that runs a computer program that is responsible for accepting HTTP requests from clients, which are known as web browsers, and serving them HTTP responses along with optional data contents, which usually are web pages such as HTML documents and linked objects (images, etc).

A “web search engine” is a search engine designed to search for information on the World Wide Web. Information may consist of web pages, images and other types of files. Web search engines operate algorithmically or can be a mixture of algorithmic and human input. Some popular web search engines are “Google” and “Yahoo”.

A “search result listing” is a list of references provided by the search engine.

A “link” (often known as hyperlink) is a technique for referring to another document or page in the web page. A link has two ends, called anchors, and a direction. The link starts at the source anchor and points to the destination anchor. The most common destination anchor is a URL used in the World Wide Web. This can refer to a document, e.g. a webpage or other resource, or to a position in a webpage. A web browser usually displays a hyperlink in some distinguishing way, e.g. in a different color, font or style. In a graphical user interface, the appearance of a mouse cursor may change into a hand motif to indicate a link. In most graphical web browsers, links are displayed in underlined blue text but underlined purple text when cached. When the user activates the link (e.g. by clicking on it with the mouse) the browser will display the target of the link.

A “thumbnail image” is a reduced-size version of an image, optionally used in the present invocation for displaying the home page of a specific web site. These images are called thumbnails to emphasize their small size. The scaled down image provides condensed information. For example, a thumbnail image of a web page of a web site provides an idea about the site.

A “related link” is a link to a site that contains information that is related to the current site.

Pay per click (PPC) is an advertising model used on search engines, advertising networks, and content websites/blogs, where advertisers only pay when a user actually clicks on an ad to visit the advertiser's website. Advertisers bid on keywords they predict their target market will use as search terms when they are looking for a product or service. When a user types a keyword query matching the advertiser's keyword list, or views a page with relevant content, the advertiser's ad may be shown. These ads are called a “dynamic thumbnail sponsored link” or “sponsored ads” and appear next to or above the “natural” or organic results on search engine results pages, or anywhere a webmaster/blogger chooses on a content page. Pay per click ads may also appear on content network websites. In this case, ad networks such as Google AdSense and Yahoo! Publisher Network attempt to provide ads that are relevant to the content of the page where they appear, and no search function is involved.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 illustrates a typical web page according to the present invention that includes the toolbar of the related links.

FIG. 2 is a close-up of one of the thumbnail images.

FIG. 3 is a high-level flow diagram of the computer-implemented method for displaying the thumbnail images of the related sites in a web site page.

FIG. 4 is a diagram that illustrates the interface between the application and the database for retrieving the related links.

FIG. 5 is a schematic drawing of the system.

FIG. 6 illustrates a web page of another embodiment of the system in which the user can personalize the toolbar.

FIG. 7 is a diagram that illustrates the mechanism for displaying related sites.

FIG. 8 is an exemplary diagram that illustrates the mechanism for searching related sites.

FIG. 9 is an exemplary diagram that illustrates the mechanism of choosing the sponsored advertisement.

### DETAILED DESCRIPTION

The present invention is of a system and method for viewing visual information about one or more web sites that are related or similar to the web site that is currently being displayed, for example with a web browser or other software interface. The system and method assist the user to access related web sites and also may optionally expand the knowledge of the user in regard to a subject of interest that is being displayed through the web site. The related web sites are shown as links within a user interface, which may optionally be placed at either side, above or below the web page being displayed, or indeed at any other location. Each link is accompanied by a thumbnail image of the page to which it links. The link may optionally be embedded within the thumbnail or alternatively may be displayed separately from the thumbnail image. The links and the thumbnail images are preferably displayed on a special toolbar. The toolbar may optionally appear on each side of the page (horizontally on the left side, horizontally on the right side, vertically at the bottom of the page or vertically at the top of the page) or indeed at any other location.

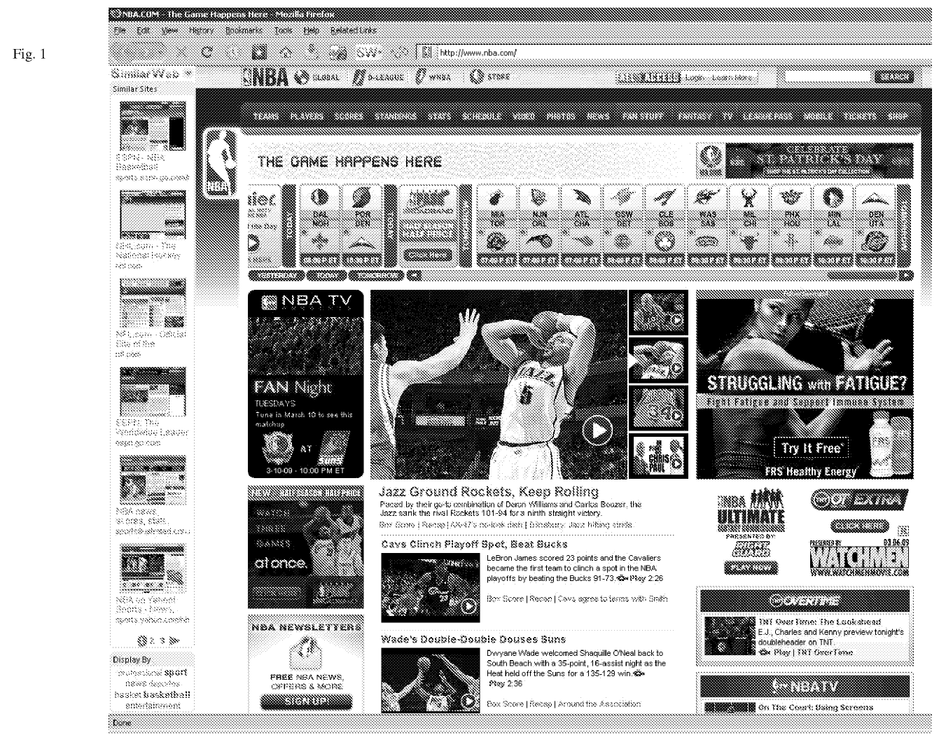

FIG. 1 illustrates a typical web page that includes the thumbnail images of the related links. On the left hand side of the page a toolbar with thumbnail images is presented. The example shows the NBA web page and the related links are all sports links. Clicking on any of the images or link opens up the site to which this image is linked. The toolbar preferably presents the most popular related links, however, the user can preferably scroll on the list (and/or otherwise manipulate the list view) to view all of the other related links.

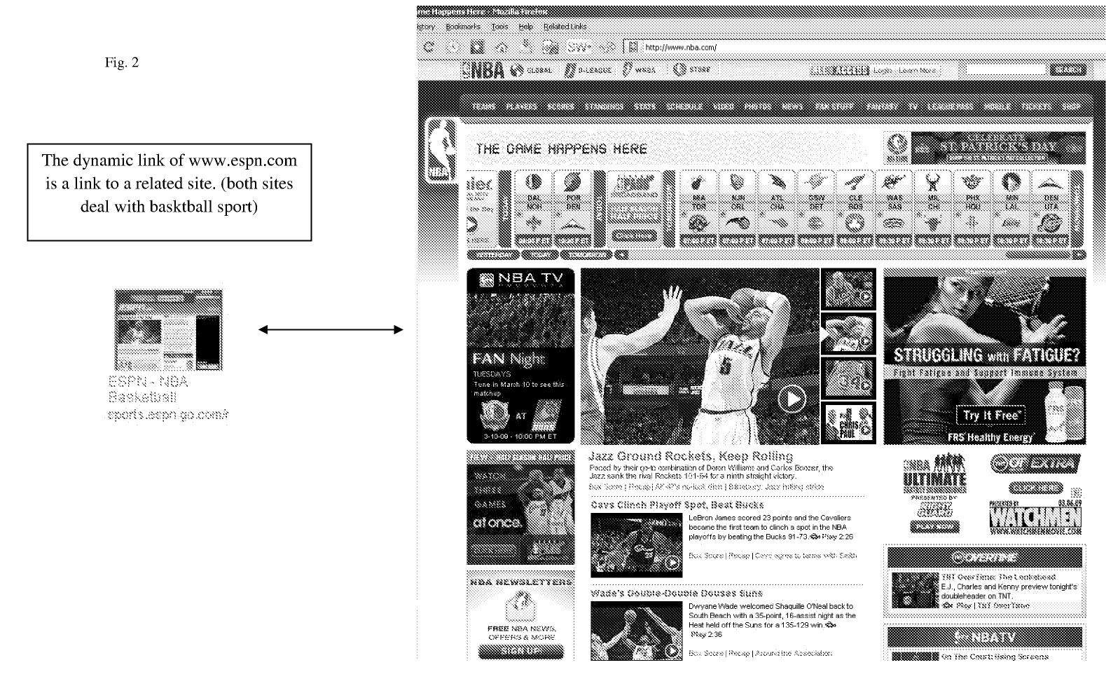

FIG. 2 is a close-up of one of the thumbnail images. The image is of a sport link (espn.com) which is related to the current web page (nba.com).

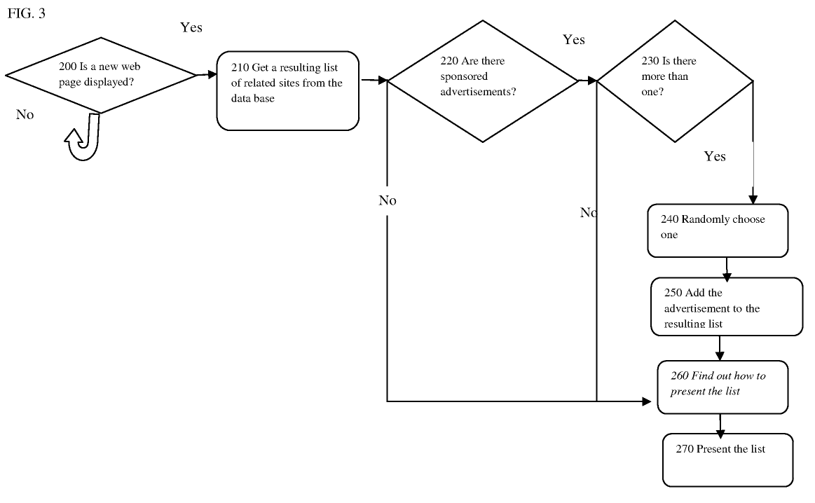

FIG. 3 is a high-level flow diagram of the computer-implemented method for displaying the thumbnail images of the related links in a web site page. First it is determined whether a new web domain is being displayed (200). For example when the user opens up “CNN.com” site from any of the browsers on which the application is installed opening such a web site preferably constitutes a new display. Optionally, the display of a new web page within a web site is also considered to a new display, even if another web page on the same site had already been displayed.

If a new web page and/or web site and/or web domain is detected, then one or more new options related to the new web page and/or website are preferably dynamically obtained, such as for example preferably retrieving one or more related links optionally from a database or other storage (210). For example if CNN site is displayed, related sites might be other news sites. In addition, thumbnail images of these sites, or other visual information (preferably summary visual information), are preferably obtained.

Next the database or other storage is preferably checked to determine whether there are sponsored advertisements that are related to this site. (220) If so then the application checks if there is more than one such sponsored advertisement (230). If there is more than one then one such advertisement is preferably selected. (240). The link of the advertisement is preferably attached to the result list. (250). Preferably, a presentation mode is selected for the toolbar (the possible options preferably include but are not limited to: vertically to the left side of the page, vertically to the right side of the page, horizontally on the top of the page or horizontally on the bottom of the page). (260). Next the toolbar is preferably displayed. (270)

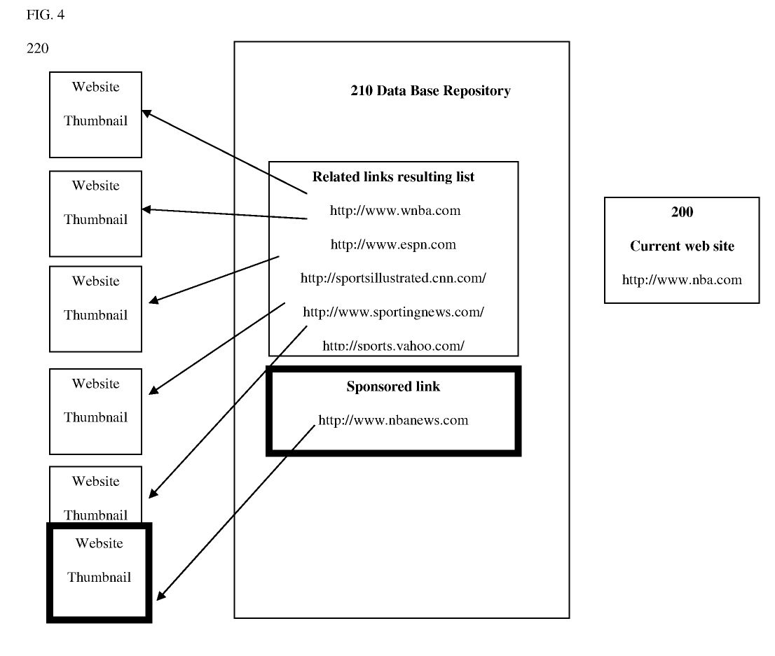

FIG. 4 is a diagram that illustrates the interface between the application and the database for retrieving the related links. First the application detects that a new web site is opened (200). Next the application queries the data base for related links (210), after which the links are presented to the user (220).

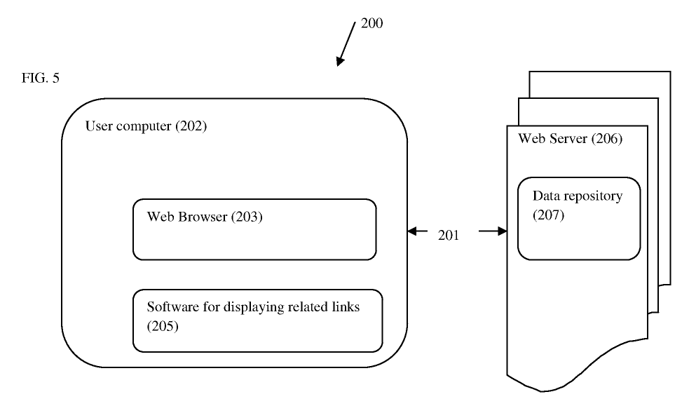

FIG. 5 is a schematic drawing of the system. As shown, a system 100 features, optionally, a user computer 202 and preferably web servers 206. Software for displaying related links 205 is shown as optionally being installed on the user computer while the servers 206 are preferably part of the internet. Software 205 is responsible for displaying related sites on a web page. Related sites are preferably displayed as thumbnail images and links on a dedicated toolbar. Each server 206 is responsible for storing web pages and optionally features data repository 207. Data repository 207, optionally and without being limited, stores the linkage between web pages and sponsored advertisement and preferably stores the related links, such that analysis of similar is optionally and preferably performed by web server 206; however, alternatively it is performed by software 205 on user computer 202. Communication between the web browser and server 203 and the web server 206 is performed through a communication channel 201, which may optionally be wired, or wireless. For example, communication channel 201 may optionally comprise a wireless packet-data network such as GPRS, EDGE, UMTS (WCDMA), EVDO, WiFi, etc. Preferably, communication is based upon IP (Internet Protocol). Computer 202 and server 206 preferably communicate according to HTTP/HTTPS. User computer 202 can optionally be any other media platform for example including but not limited to a computer monitor and/or other computer display, television, PDA, iPod™, MP3 player, pager, mobile telephone, smart phone or the like, on which the related web pages are displayed.

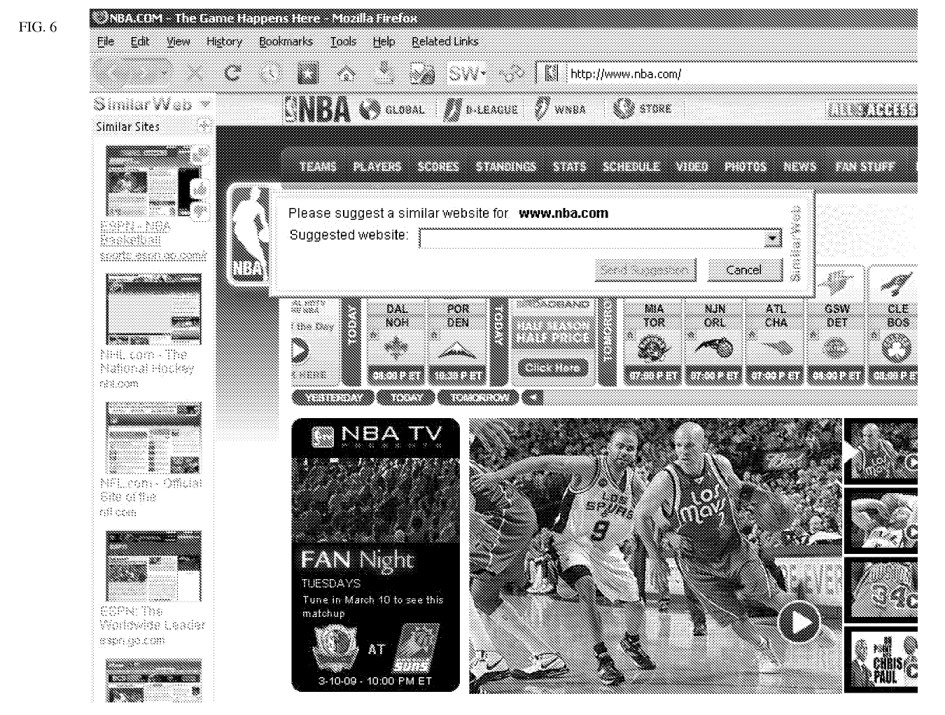

FIG. 6 illustrates a web page of another embodiment of the system in which the user can personalize the toolbar. As shown in the picture, the user is optionally given the option to replace any of the related links on the toolbar with any other link.

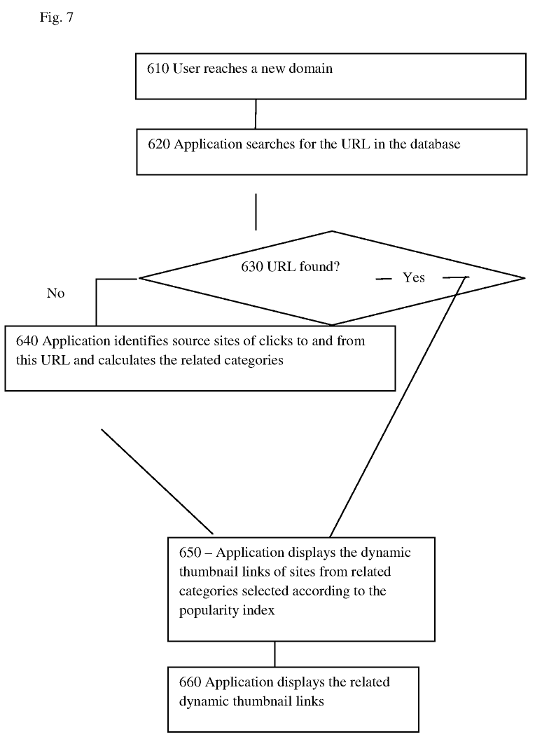

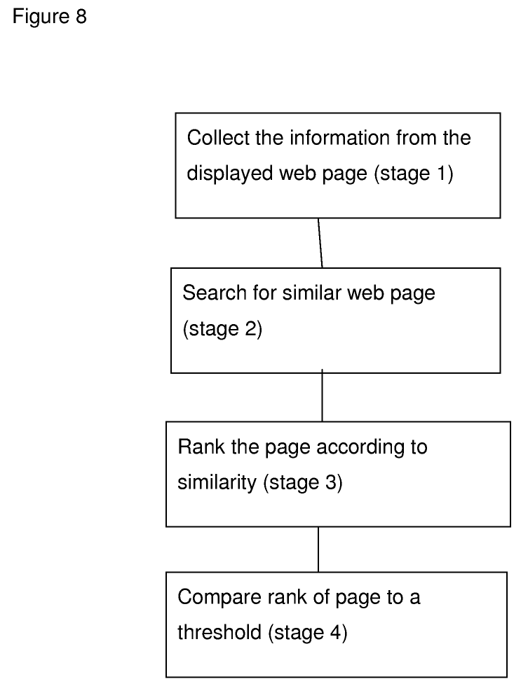

FIG. 7 is a diagram that illustrates the mechanism for searching related links. The search is optionally performed whenever the user reaches a new domain (610). Previous search results are preferably kept in the database. Optionally, each site is assigned with index of popularity, which is optionally updated as a result of the user's behavior. For example: any attempt to open a related link optionally increases the level of the popularity of the related sites. The application first looks for previous search results (620). If results are not found (630) then the robot searches for the related links and sorts them according to the popularity (640). The searching of related links is explained in greater detail in FIG. 8. In both cases, the dynamic thumbnail of related links are presented, preferably in the order of popularity so that the most popular link is optionally displayed at the top and optionally scrolling enables to view less popular links (650). The application optionally displays the links of the related links in addition to the thumbnails (660).

FIG. 8 is a diagram that illustrates the mechanism for searching related links. Related sites are preferably found according to information residing in the web page. Such information can be, for example, metadata (information regarding the web page that is included in the web page and is usually defined in the header of the page), text that appears on the web page and the like, or a combination thereof. The system preferably compares this information to the information that resides on the currently displayed web page. The system looks for identity of information (for example for appearance of the same key words on both the current displayed page and the page that it's relevancy is currently tested) or for similarity of information or a combination thereof.

In the drawing, in stage 1 the system collects the information that is available in the displayed web page. Such information can be, for example, key words, meta-data, text and the like. In stage 2, the system searches for similar pages by using the information found in stage 1. In stage 3, the system ranks the information according to the similarity. Such ranking can be done, for example, a combination of the ratio of similar words, the ratio of identical words, the ratio of similar text and the like. Similarity may optionally be defined heuristically, for example according to a dictionary in which words or phrases considered to be “similar” are provided or defined. In stage 4, the system compares the rank of each page to a predefined threshold in order to decide if the page is similar.

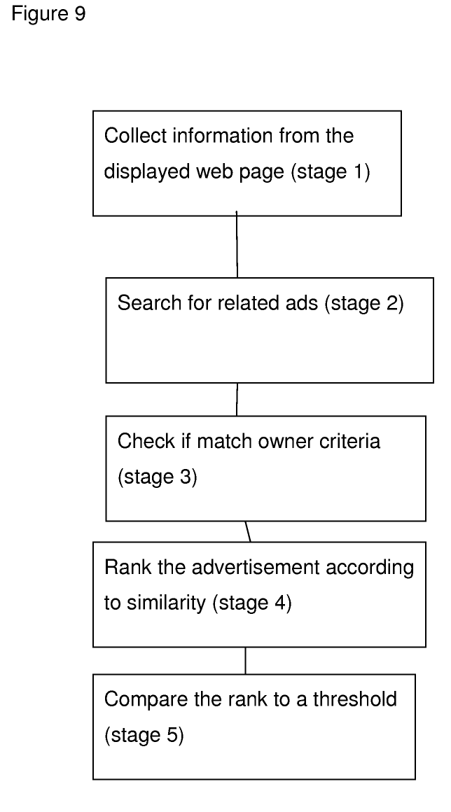

FIG. 9 is an exemplary diagram that illustrates the mechanism of choosing the sponsored advertisement. The system optionally selects the dynamic thumbnail sponsored link to be displayed according to criteria such as similarity to the current displayed page, web page owner requirements, information about the user, the audience to which the web page refers to and the like. The similarity with the current displayed page is determined by using information that exists on the web page. Such information can be, for example, key words, meta data and the like. The web page owner can, for example, ban the display of advertisements of a competitor, or the displaying of immoral or offensive advertisements. Information about the user, such as the user's age and gender, the user's preferences and the like is preferably provided to the system by a third party. The audience to which the web page refers to can be obtained by the web page meta data The audience can preferably categorized according to age, gender, preferences, activities, hobbies and the like.

In the drawing, in stage 1, the system collects the information that is available in the displayed web page. Such information can be, for example, key words, meta-data, text and the like. In stage 2, the system searches for relevant advertisements by using the information found in stage 1 and also according to the information regarding the user and according to the category of the displayed page. Information about the user can be related to gender, age, hobbies and the like. The displayed web page can be categorized as being related to sports or health, for example. In stage 3, the system optionally bans advertisements that were found in stage 2 but do not match the site's owner criteria. In stage 4, the system ranks the information found in each advertisement according to the similarity. Such ranking can be done, for example, by a combination of the ratio of similar words (comparing to the displayed page), the ratio of identical words the ratio of similar text and the like. In stage 5, the system compares the rank of each advertisement to a predefined threshold in order to decide if the advertisement is relevant or not. At the end of the process, the system preferably selects one of the advertisements from the list of relevant advertisements. The selection may optionally be performed according to bidding or other pricing information, for example.

While the invention has been described with respect to a limited number of embodiments, it will be appreciated that many variations, modifications and other applications of the invention may be made.

What is claimed is:

1. A computer implemented method for displaying related information about a displayed web page to a user, comprising:
a. Analyzing the displayed web page to form an analysis;
b. Determining at least one web page being similar or related to the displayed web page according to said analysis; and
c. Displaying a thumbnail image of said at least one similar or related web page, on a display screen of a user computer to a user.

2. The method of claim 1, wherein said thumbnail image further comprises an interactive link to said at least one web page.

3. The method of claim 2 further comprising displaying an advertisement in addition to said thumbnail image.

4. The method of claim 3, wherein the web page is pre-selected by a sponsor of said advertisement.

5. The method of claim 3 further comprising displaying media advertisement.

6. The method of claim 6, wherein said media is video.

7. The method of claim 3 further comprising displaying said thumbnail image as part of said displayed web page.

8. The method of claim 3 further comprising displaying said thumbnail image as an overlay to said displayed web page.

9. The method of claim 1 wherein said determining of said at least one web page is defined according to the similarity of said web page to said displayed web site.

10. The method of claim 3 wherein said selecting of said advertisement is done according to relevancy to the displayed web page, preferences of the web site owner, personal details of the user and classification of the displayed web site.

11. The method of claim 1, wherein said displaying said thumbnail image further comprises obtaining said related or similar web page from a remote server; and converting said related or similar web page to said thumbnail image.

12. The method of claim 11, wherein said converting is performed at said user computer.

13. A system for displaying related information about a displayed web page to a user, comprising:
a. a remote web page server for serving a web page;
b. A user computer for displaying said web page; and
c. An analysis server for selecting a related web page according to said displayed web page on said user computer and for selecting at least one sponsored advertisement, wherein said related web page and said at least one sponsored advertisement are converted to thumbnails for providing to said user computer for display.

14. The system of claim 13 wherein said user computer and said server communicate via the internet network.

15. A computer implemented method for displaying related information about a displayed web page to a user, comprising:
a. Determining at least one web page being similar or related to the displayed web page;
b. Displaying a thumbnail image of said at least one web page, on a display screen;
c. determining at least one advertisement being similar or related to the displayed web page; and
d. Displaying a thumbnail image of said at least one advertisement, on a display screen.
